(19) United States
(12) Patent Application Publication
(10) Pub. No.: US 2020/0202170 A1
(43) Pub. Date: Jun. 25, 2020

(54) MODULAR AUTOTUNE FOR AUTOMATED FEED MODEL TRAINING

(71) Applicant: Microsoft Technology Licensing, LLC, Redmond, WA (US)

(72) Inventors: Kinjal Basu, Stanford, CA (US); Yunbo Ouyang, Sunnyvale, CA (US); Boyi Chen, Sunnyvale, CA (US); Zhong Zhang, Santa Clara, CA (US)

(21) Appl. No.: 16/231,199

(22) Filed: Dec. 21, 2018

(51) Int. Cl. G06K 9/62; G06F 3/0484; G06N 20/00

(52) U.S. Cl. CPC G06K 9/6228; G06K 9/6262; G06N 20/00; G06K 9/6256; G06F 3/04842

(57) ABSTRACT

Techniques for improving the accuracy, scalability, and efficiency of machine-learning models for selecting digital content items for display within a graphical user interface are disclosed herein. In some embodiments, a computer system generates corresponding evaluation values for different parameter configurations for a combination model comprising a click-through model and a viral action model, selects a subset of the different parameter configurations based on the evaluation values of the subset using a Gaussian process algorithm and a Thompson sampling algorithm, repeats the generating the corresponding evaluation values and the selecting the subset of the different parameter configurations until a single parameter configuration satisfies a convergence criteria, with each repeated generating of the corresponding evaluation values using the most recently selected subset of different parameter configurations, and then selects at least one digital content item for display on a computing device using the single parameter configuration of the combination model.

### TECHNICAL FIELD

The present application relates generally to systems, methods, and computer program products for improving the accuracy, scalability, and efficiency of machine-learning models for selecting digital content items for display within a graphical user interface.

### BACKGROUND

Current solutions for generating models for selecting which digital content items to display to in a feed of a user of an online service suffer from a lack of accuracy (e.g., relevancy), scalability, and efficiency. For example, these solutions fail to adequately optimize a model for both click-through actions and viral actions (e.g., liking, commenting, sharing). Furthermore, these solutions suffer from high computational cost. Other technical problems may arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating a feed optimization system, in accordance with an example embodiment.

FIG. 4 illustrates an indication of a digital content item, in accordance with an example embodiment.

FIG. 5 is a flowchart illustrating a method of improving the accuracy, scalability, and efficiency of machine-learning models for selecting digital content items for display within a graphical user interface (GUI), in accordance with an example embodiment.

FIG. 6 is a block diagram illustrating input and output for a machine-learning unit that utilizes a Gaussian process and Thompson sampling to determine parameter configurations for a combination model, in accordance with an example embodiment.

FIG. 7 is a flowchart illustrating a method of generating a combination model, in accordance with an example embodiment.

FIG. 8 is a block diagram illustrating an operational flow for optimizing a combinational model, in accordance with an example embodiment.

FIG. 9 is a block diagram illustrating a mobile device, in accordance with some example embodiments.

FIG. 10 is a block diagram of an example computer system on which methodologies described herein may be executed, in accordance with an example embodiment.

### DETAILED DESCRIPTION

### I. Overview

Example methods and systems of improving the accuracy, scalability, and efficiency of machine-learning models for selecting digital content items for display within a graphical user interface are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein, which provide methods for improving the accuracy, scalability, and efficiency of machine-learning models for selecting digital content items for display within a graphical user interface. In some example embodiments, a computer system repeats a cycle of generating corresponding evaluation values for different parameter configurations for a combination model comprising a click-through model and a viral action model and selecting a subset of the different parameter configurations based on the evaluation values of the subset until a single parameter configuration satisfies a convergence criteria. Each repeated generating of the corresponding evaluation values uses the most recently selected subset of different parameter configurations, thereby eventually narrowing the selected subset of different parameter configurations down to the optimal single parameter configuration. By performing these operations, the computer system optimizes the combination model in an accurate, scalable, and efficient manner, addressing click-through actions and viral actions with respect to the selection of digital content items for display.

The techniques of the present disclosure involve a non-generic, unconventional, and non-routine combination of operations. By applying one or more of the solutions disclosed herein, some technical effects of the system and method of the present disclosure are to improve the accuracy, scalability, and efficiency of machine-learning models for selecting digital content items for display within a graphical user interface. As a result, the functioning of the computer system of the online service is improved. Other technical effects will be apparent from this disclosure as well.

### II. Detailed Example Embodiments

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

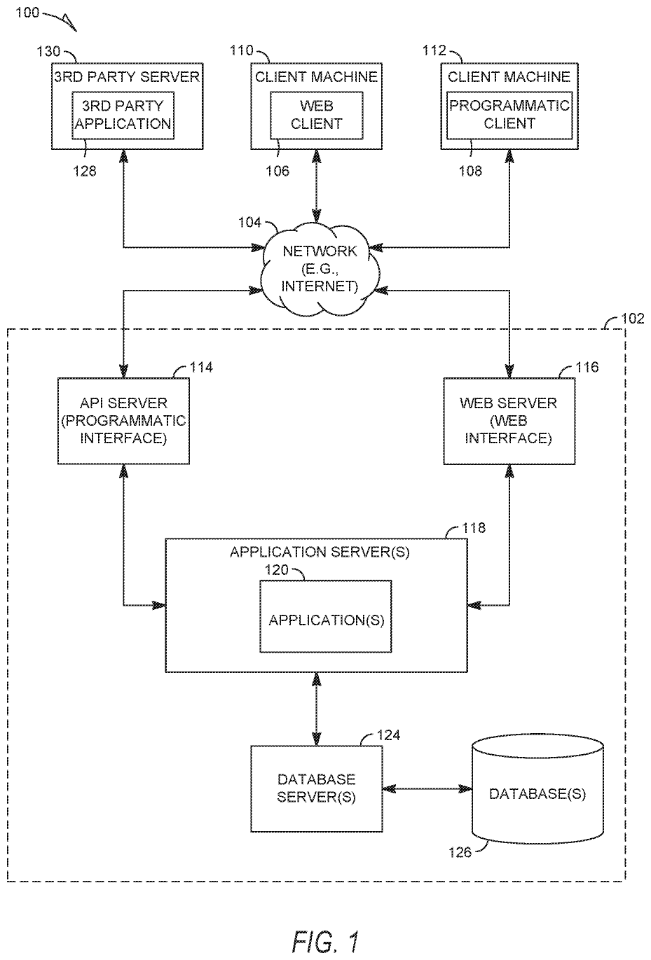

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

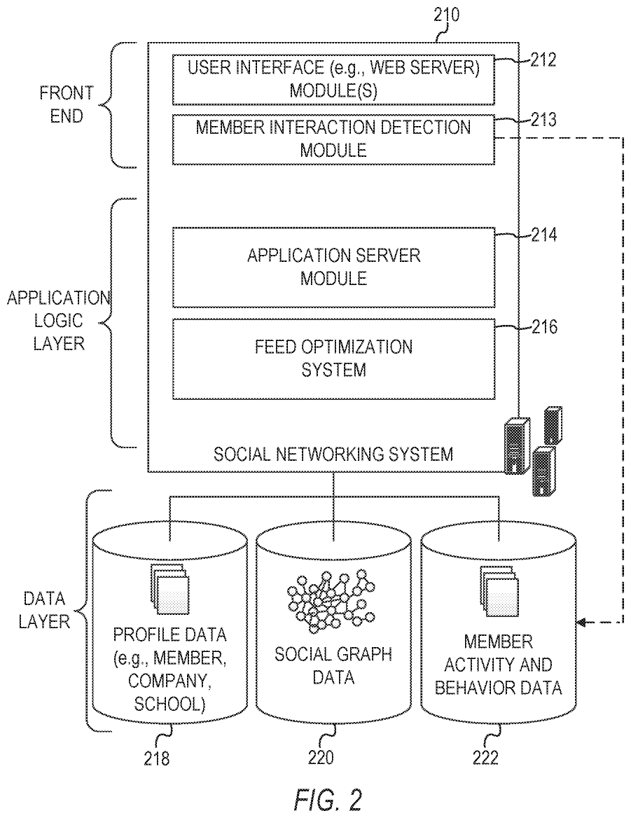

In some embodiments, the networked system 102 may comprise functional components of a social networking service. FIG. 2 is a block diagram showing the functional components of a social networking system 210, including a data processing module referred to herein as a feed optimization system 216, for use in social networking system 210, consistent with some embodiments of the present disclosure. In some embodiments, the feed optimization system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the feed optimization system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in 2 by the database 222. This logged activity information may then be used by the feed optimization system 216. The members' interactions and behavior may also be tracked, stored, and used by the feed optimization system 216 residing on a client device, such as within a browser of the client device, as will be discussed in further detail below.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the feed optimization system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

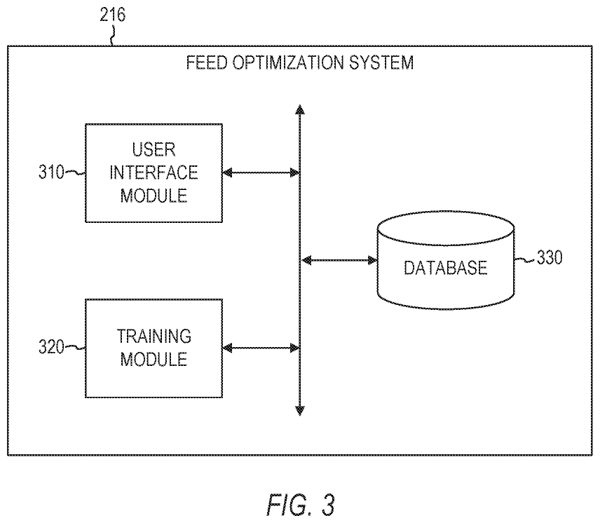

FIG. 3 is a block diagram illustrating the feed optimization system 216, in accordance with an example embodiment. In some embodiments, the feed optimization system 216 comprises any combination of one or more of a user interface module 310, a training module 320, and one or more databases 330. The user interface module 310, the training module 320, and the database(s) 330 can reside on a computer system, or other machine, having a memory and at least one processor (not shown). In some embodiments, the user interface module 310, the training module 320, and the database(s) 330 can be incorporated into the application server(s) 118 in FIG. 1. In some example embodiments, the database(s) 330 is incorporated into database(s) 126 in FIG. 1 and can include any combination of one or more of databases 218, 220, and 222 in FIG. 2. However, it is contemplated that other configurations of the user interface module 310 and the training module 320, as well as the database(s) 330, are also within the scope of the present disclosure.

In some example embodiments, one or more of the user interface module 310 and the training module 320 is configured to perform various communication functions to facilitate the functionality described herein, such as by communicating with the social networking system 210 via the network 104 using a wired or wireless connection. Any combination of one or more of the user interface module 310 and the training module 320 may also provide various web services or functions, such as retrieving information from the third party servers 130 and the social networking system 210. Information retrieved by the any of the user interface module 310 and the training module 320 may include profile data corresponding to users and members of the social networking service of the social networking system 210.

Additionally, any combination of one or more of the user interface module 310 and the training module 320 can provide various data functionality, such as exchanging information with the database(s) 330 or servers. For example, any of the user interface module 310 and the training module 320 can access member profiles that include profile data from the database(s) 330, as well as extract attributes and/or characteristics from the profile data of member profiles. Furthermore, the one or more of the user interface module 310 and the training module 320 can access profile data, social graph data, and member activity and behavior data from the database(s) 330, as well as exchange information with third party servers 130, client machines 110, 112, and other sources of information.

In some example embodiments, the user interface module 310 is configured to select one or more digital content items for display within a graphical user interface on a computing device using a combination model. A digital content item comprises any content that exists in the form of digital data. Examples of digital content items include, but are not limited to, text, copies of documents, links to documents, images, videos, or any combination thereof. In some example embodiments, the user interface module 310 displays digital content items in a feed of content that is presented to a user of a networked site, such as to a member of a social networking site. Such content feeds may be personalized for the specific user to which they are being presented. For example, the selection of digital content items in a feed may be determined based on information about the specific user, such as profile data (e.g., from database 218 in FIG. 2), social graph data (e.g., from database 220 in FIG. 2), and member activity and behavior data (e.g., from database 222 in FIG. 2).

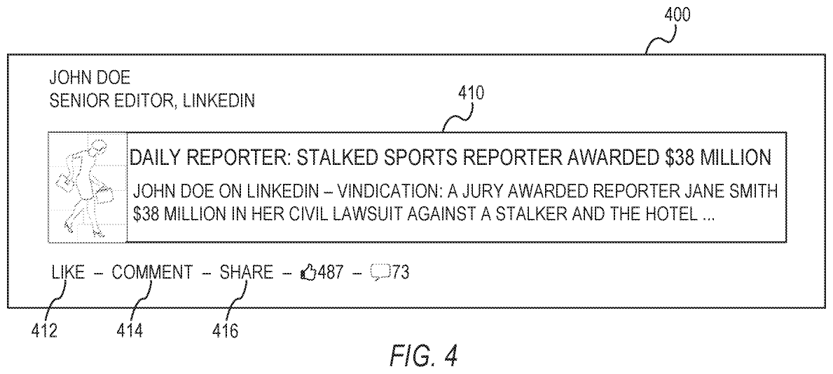

FIG. 4 illustrates an indication 400 of a digital content item, in accordance with an example embodiment. In some example embodiments, the indication 400 of the digital content item is displayed within a graphical user interface as part of a feed of a user. The indication 400 of the digital content item may comprise a representation or portion of the digital content item. For example, in FIG. 4, the digital content item comprises a news article, and the indication 410 400 of the digital content item comprises a headline or title of the news article (e.g., “DAILY REPORTER.: STALKED SPORTS REPORTER AWARDED $38 MILLION”). In some example embodiments, the indication 400 of the digital content item comprises a selectable user interface element 410 configured to trigger a navigation to the digital content item. For example, in response to a user selection (e.g., click, tap) of the selectable user interface element 410, the user interface module 310 navigates the browser (e.g., a web browser) being used by the user to view the indication 400 of the digital content item to a page displaying the actual digital content item. In the example shown in FIG. 4, if the user selects the selectable user interface element 410, then the browser being used by the user is navigated to a page on which the actual news article may be viewed. The selection by a user to navigate to a digital content item is a click-through action. In some example embodiments, the combination model used by the user interface model 310 to select digital content items to display to a user is configured to optimize the probability that the user will perform a click-through action for the digital content items when presented with the indications 400 of the digital content items.

In some example embodiments, the combination model used by the user interface model 310 to select digital content items to display to a user is also configured to optimize the probability that the user will perform at least one viral action for the digital content items when presented with the indications 400 of the digital content items. Viral actions comprising online actions that are visible to at least one other user. Examples of viral actions include, but are not limited to, liking a digital content item, commenting on a digital content item, and sharing a digital content item. For example, in FIG. 4, the indication 400 of the digital content item comprises a selectable user interface element 412 for liking the digital content item, a selectable user interface element 414 for commenting on the digital content item, and a selectable user interface element 416 for sharing the digital content item. The selectable user interface element 412 for liking the digital content item is configured to, in response to its selection, store and display in association with the digital content item a signal that the user likes the digital content item. The selectable user interface element 414 for commenting on the digital content item is configured to, in response to its selection, enable the user to submit a comment that will be stored and displayed in association with the digital content item, such as by providing a text field in which the user may enter and submit a comment for the digital content item. The selectable user interface element 416 for sharing the digital content item is configured to, in response to its selection, share the digital content item with one or more other users, such as with other users that are connected to the user.

The training model 320 is configured to employ non-generic, unconventional, and non-routine machine learning operations to optimize the combination model for click-through actions and viral actions. In some example embodiments, the combination model comprises a combination of a click-through model and a viral action model. The combination model may also comprise one or more additional models combined with the click-through model and the viral action model. In some example embodiments, the click-through model is configured to generate a click-through prediction corresponding to a probability that a user will perform a click-through action to navigate to a digital content item when presented with an indication of the digital content item, while the viral action model is configured to generate a viral action prediction corresponding to a probability that the user will perform at least one viral action for the digital content item when presented with the indication of the digital content item.

In some example embodiments, the combination model is configured to generate a corresponding score for each digital content item being considered for selection and is represented as:

score=pCTR+α*pViral*addModel,

where pCTR is a score generated by the click-through model based on the probability that a user will perform a click-through action to navigate to a digital content item when presented with an indication of the digital content item, pViral is a score generated by the viral action model based on the probability that the user will perform at least one viral action for the digital content item when presented with the indication of the digital content item, and a is a combination parameter configured to weight the viral action model pViral with respect to the click-through model pCTR. The addModel comprises one or more optional models that may be used along with the click-through model and the viral action model in generating a score for a digital content item. For example, the addModel may he configured to represent the average number of online actions for a particular type of digital content item to which the digital content item being considered for selection corresponds.

In some example embodiments, the user interface module 310 uses the combination model to generate corresponding scores for digital content items being considered for selection to be display to a user, rank the digital content items based on their scores, and then select one or more of the digital content items for display to the user based on the ranking. For example, the user interface module 310 may select the top N ranked digital content items for display to the user, where N comprises a positive integer less than the total number of digital content items that were scored and ranked.

In some example embodiments, the training module 320 implements an automatic tuning system to reduce the computational cost of training the combination model by using Thompson sampling and expected improvement (EI) Bayesian optimization. The training module 320 may use an architecture that provides parallel execution of training the different models of the combination model, such as the click-through model and the viral action model.

In some example embodiments, the training module 320 estimates the optimal gradient boosting models for the click-through model, the viral action model, and any additional models of the combination model, through a Gaussian process using an expected improvement (EI) acquisition function, thereby determining hyperparameters. Using gradient boosting, such as extreme gradient boosting (XGBoost), to determine the hyperparameters significantly reduces the search space and enables the training module 320 to find the optimal hyperparameters in much less time than other solutions for determining hyperparameters. Following the determination of the hyperparameters using gradient boosting, the training module 320 may then, for a set of choices of regularization weights λ, fit logistic regression models for the click-through model and the viral action model with given hyperparameters. Then, the training module 320 may combine the click-through model and the viral action model into a single combination model with the determined weights from the previous operations and generate a reward report for click-through actions and viral actions, computing a click-through rate and a viral action rate using the combination model applied to training data. The training module 320 may then use the following evaluation function to generate corresponding evaluation values for a plurality of parameter configurations (λ, α):

f(λ, α)=VAR+2/(1+exp(−100*(CTR−threshold))),

where VAR is the viral action rate, CTR is the click-through rate, and the threshold is a control click-through rate corresponding to a non-optimized model used for selecting digital content items. This evaluation function is based on an optimization objective of maximizing viral actions, while also keeping the click-through rate at a specific threshold. Therefore, maximizing the evaluation function f is equivalent to this optimization objective. In some example embodiments, the training module 320 is configured to generate the Gaussian process posterior of the above evaluation function f(λ, α) in the two-dimensional space and obtain the next set of parameters on which the training module 320 is to evaluate. The training module 320 may then return to the above-discussed fitting of the logistic regression models and repeat the process until convergence of the parameters selected based on the evaluation values. At the point of convergence, the model and its hyperparameters have been optimized.

In some example embodiments, the training module 320 is configured to generate a corresponding evaluation value for each one of a plurality of different parameter configurations (λ, α) for the combination model. For example, the training module 320 may use the evaluation function f(λ, α) discussed above to generate the corresponding evaluation values.

In some example embodiments, the training module 320 is configured to select a subset of the plurality of different parameter configurations based on the evaluation values of the subset. In some example embodiments, the training module 320 is configured to select a subset of the plurality of different parameter configurations based on the evaluation values of the subset using a Gaussian process algorithm and a Thompson sampling algorithm. A Gaussian process is a collection of random variables indexed by time or space, such that every finite collection of those random variables has a multivariate normal distribution (e.g., every finite linear combination of them is normally distributed). The distribution of a Gaussian process is the joint distribution of all those random variables, and as such, it is a distribution over functions with a continuous domain (e.g., time or space). A machine-learning algorithm that involves a Gaussian process uses lazy learning and a measure of the similarity between points to predict the value for an unseen point from training data. Thompson sampling is a heuristic for choosing actions that addresses the exploration-exploitation dilemma in the multi-armed bandit problem, which is a problem in which a fixed limited set of resources must be allocated between competing (alternative) choices in a way that maximizes their expected gain, when each choice's properties are only partially known at the time of allocation, and may become better understood as time passes or by allocating resources to the choice. Thompson sampling comprises choosing the action that maximizes the expected reward with respect to a randomly drawn belief.

In some example embodiments, the training module 320 is configured to repeat the generating of the corresponding evaluation value and the selecting of the subset of the plurality of different parameter configurations discussed above until a single parameter configuration satisfies a convergence criteria. In some example embodiments, the convergence criteria comprises the selected subset comprising only the single parameter configuration. Each repeated performance of the generating of the corresponding evaluation value uses the most recently selected subset of different parameter configurations in place of the plurality of different parameter configurations for the combination model. Based on the training module 320 determining that the single parameter configuration satisfies the convergence criteria, the single parameter configuration of the combination model may be used by the user interface module 310 to select at least one digital content item for display on a computing device. In some example embodiments, this selection of the digital content item(s) is part of an online testing of the combination model.

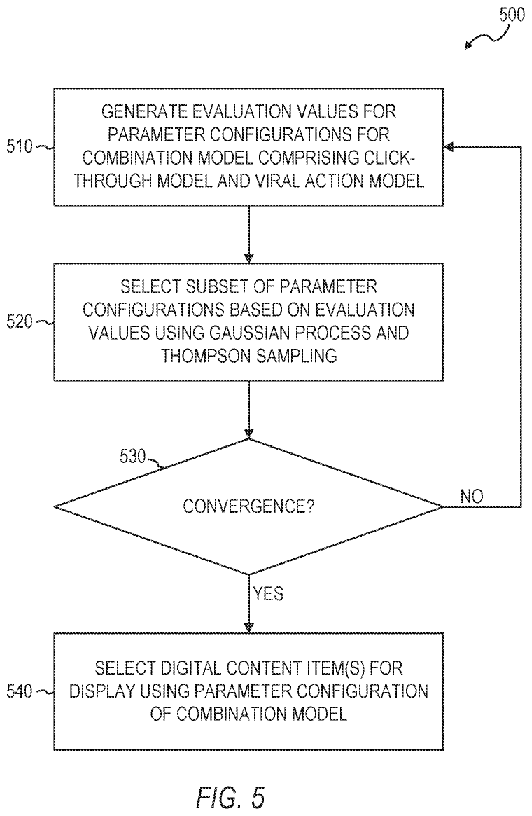

FIG. 5 is a flowchart illustrating a method 500 of improving the accuracy, scalability, and efficiency of machine-learning models for selecting digital content items for display within a graphical user interface (GUI), in accordance with an example embodiment. The method 500 can be performed by processing logic that can comprise hardware (e.g., circuitry, dedicated logic, programmable logic, microcode, etc.), software (e.g., instructions run on a processing device or a combination thereof. In one implementation, the method 500 is performed by the feed optimization system 216 of FIG. 3, or any combination of one or more of its modules, as described above.

At operation 510, the feed optimization system 216 generates a corresponding evaluation value for each one of a plurality of different parameter configurations for a combination model comprising a click-through model and a viral action model. In some example embodiments, the click-through model is configured to generate a click-through prediction corresponding to a first probability that a user will perform a click-through action to navigate to a digital content item when presented with an indication of the digital content item, while the viral action model is configured to generate a viral action prediction corresponding to a second probability that the user will perform at least one viral action for the digital content item when presented with the indication of the digital content item. In some example embodiments, the viral action(s) comprises at least one online action that is visible to at least one other user. For example, the viral action(s) may comprise one or more of liking the digital content item, commenting on the digital content item, and sharing the digital content item.

At operation 520, the feed optimization system 216 selects a subset of the plurality of different parameter configurations based on the evaluation values of the subset. In some example embodiments, the feed optimization system 216 selects the subset of the plurality of different parameter configurations based on the evaluation values using a Gaussian process algorithm and a Thompson sampling algorithm. However, other algorithms may be used by the feed optimization system 216 in selecting the subset based on the evaluation values.

At operation 530, the feed optimization system 216 determines whether the selected subset of parameter configurations satisfies a convergence criteria. In some example embodiments, the convergence criteria comprises the selected subset comprising only a single parameter configuration.

If it is determined at operation 530 that the convergence criteria has not been satisfied, then the feed optimization system 216 returns to operation 510, where evaluation values are generated for the subset of parameter configurations selected at operation 520, and then proceeds to operation 520, where the feed optimization system 216 again selects another subset of the configuration parameters. In some example embodiments, the feed optimization system 216 repeats operation 510 of generating the corresponding evaluation value and operation 520 of selecting the subset of the plurality of different parameter configurations until a single parameter configuration satisfies the convergence criteria at operation 530. In some example embodiments, each repeated generating of the corresponding evaluation value at operation 510 uses the most recently selected subset of different parameter configurations for the combination model.

If it is determined at operation 530 that the convergence criteria has been satisfied, then the feed optimization system 216 proceeds to operation 540, where it selects at least one digital content item for display on a computing device using the single parameter configuration of the combination model. In some example embodiments, this selection of the digital content item(s) at operation 540 is part of an online testing of the combination model.

It is contemplated that any of the other features described within the present disclosure can he incorporated into the method 500.

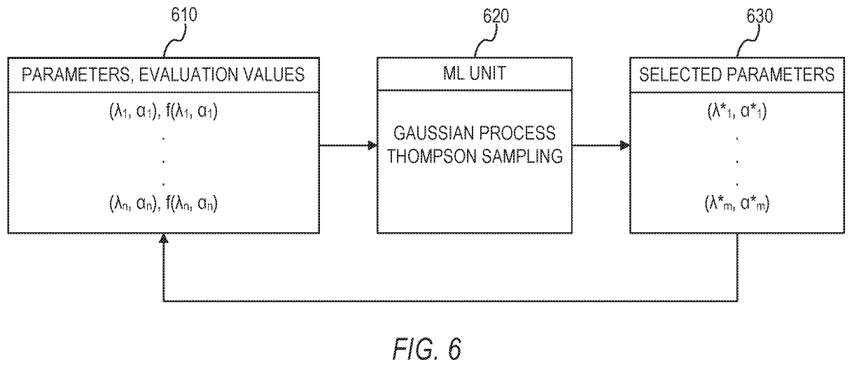

FIG. 6 is a block diagram illustrating input 610 and output 630 for a machine-learning unit 620 that utilizes a Gaussian process and Thompson sampling to determine parameter configurations for a combination model, in accordance with an example embodiment. The machine learning unit 620 can be implemented by processing logic that can comprise hardware (e.g., circuitry, dedicated logic, programmable logic, microcode, etc.), software (e.g., instructions run on a processing device), or a combination thereof. In one implementation, the machine-learning unit 620 is implemented by the feed optimization system 216 of FIG. 3, or any combination of one or more of its modules (e.g., the training module 320), as described above.

The input 610 comprises a set of data that evaluation values each corresponding to a different parameter configuration for the combination model. For example, the input 610 may comprise evaluation values f(λ₁, α) . . . f(λₙ, αₙ) for parameter configurations (λ₁, α₁) . . . (λₙ, αₙ). The machine-learning unit 620 performs a Gaussian process algorithm and a Thompson sampling algorithm to select a subset of the plurality of different parameter configurations based on the evaluation values. As a result, the machine-learning unit 620 generates the output 630, which comprises the selected subset. For example, the output 630 may comprise parameter configurations (λ*₁, α*₁) . . . (λ*ₘ, α*ₘ), which are a subset of the parameter configurations (λ₁, α₁) . . . (λₙ, αₙ) corresponding to the evaluation values f(λ₁, α₁) . . . f(λₙ, αₙ) fed into the machine-learning unit 620. The subset of parameter configurations of in the output 630 are then used as the parameter configurations used to generate corresponding evaluation values of the input 610 that are fed into the machine-learning unit 620 to generate another round of output 630. This cycle of feeding the input 610 into the machine-learning unit 620 to generate the output 630, which is then used to generate an additional round of the input 610 that is again fed into the machine-learning unit 620 is repeated until the machine-learning unit 620 reduces the subset of parameter configurations in the output 630 to a point of convergence. For example, this cycle may continue until the subset of parameter configurations comprises only a single parameter configuration, at which point the single parameter configuration is used in an online use of the combination model to select digital content items for display. It is contemplated that any of the other features described within the present disclosure can be incorporated into the operational flow 600.

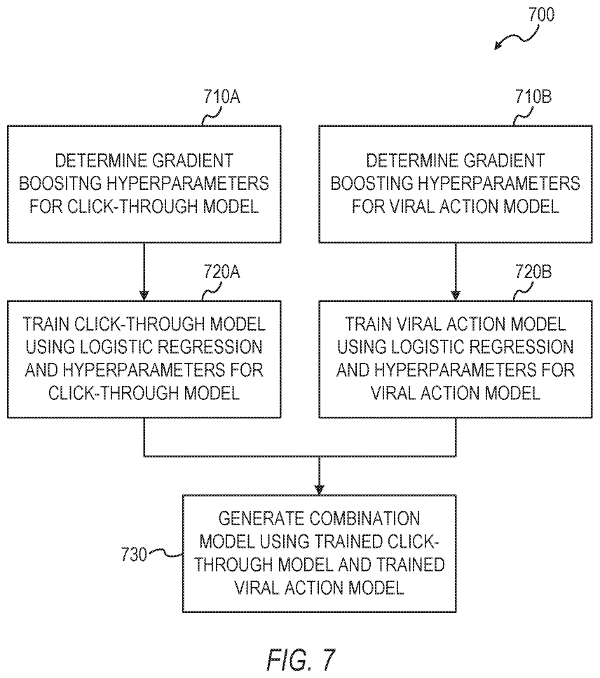

FIG. 7 is a flowchart illustrating a method 700 of generating a combination model, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the feed optimization system 216 of FIG. 3, or any combination of one or more of its modules, as described above.

In some example embodiments, the feed optimization system 216 performs operations in parallel for the different models of the combination model. For example, the feed optimization system 216 may perform operations for optimizing the click-through model in parallel with operations for optimizing the viral action model.

At operation 710A, the feed optimization system 216 determines a first set of hyperparameters of a first gradient boosting algorithm for the click-through model using a first Gaussian process via expected improvement criteria and a first set of training data comprising indications of whether users performed the click-through action to navigate to digital content items when presented the digital content items. At operation 710B, the feed optimization system 216 determines a second set of hyperparameters of a second gradient boosting algorithm for the viral action model using a second Gaussian process via expected improvement criteria and a second set of training data comprising indications of whether users performed the at least one viral action for digital content items when presented with indications of the digital content items. The operations 710A and 710B may be performed in parallel. In some example embodiments, the first set of hyperparameters and the second set of hyperparameters comprise at least one of a maximum depth of trees and a learning rate. In some example embodiments, the gradient boosting algorithm comprises an XGBoost algorithm. In some example embodiments, the determining of the first set of hyperparameters for the click-through model at operation 710A comprises tuning the first set of hyperparameters of the first gradient boosting algorithm using the first Gaussian process via expected improvement criteria to maximize an area under the curve (AUC) metric for the click-through model, and the determining of the second set of hyperparameters for the viral action model at operation 710B comprises tuning the second set of hyperparameters using the second gradient boosting algorithm using the second Gaussian process via expected improvement criteria to maximize the AUC metric for the viral action model.

At operation 720A, the feed optimization system 216 trains the click-through model using a logistic regression algorithm, the first set of hyperparameters, and the first set of training data. At operation 720B, the feed optimization system 216 trains the viral action model using the logistic regression algorithm, the second set of hyperparameters, and the second set of training data. The operations 720A and 720B may be performed in parallel. In some example embodiments, each one of the plurality of different parameter configurations comprises a regularization weight parameter for the click-through model and a regularization weight parameter for the viral action model, with the regularization weight parameter for the click-through model being used in the training of the click-through model using the logistic regression algorithm, and the regularization weight parameter for the viral action model being used in the training of the viral action model using the logistic regression algorithm.

At operation 730, the feed optimization system 216 generates the combination model using the trained dick-through model and the trained viral action model. In some example embodiments, the combination model is configured to generate corresponding scores for digital content items based on the click-through model and the viral action model, and each one of the plurality of different parameter configurations comprises a combination parameter, such as combination parameter a, configured to weight the viral action model with respect to the click-through model in generating the corresponding scores.

It is contemplated that any of the other features described within the present disclosure can be incorporated into the method 700.

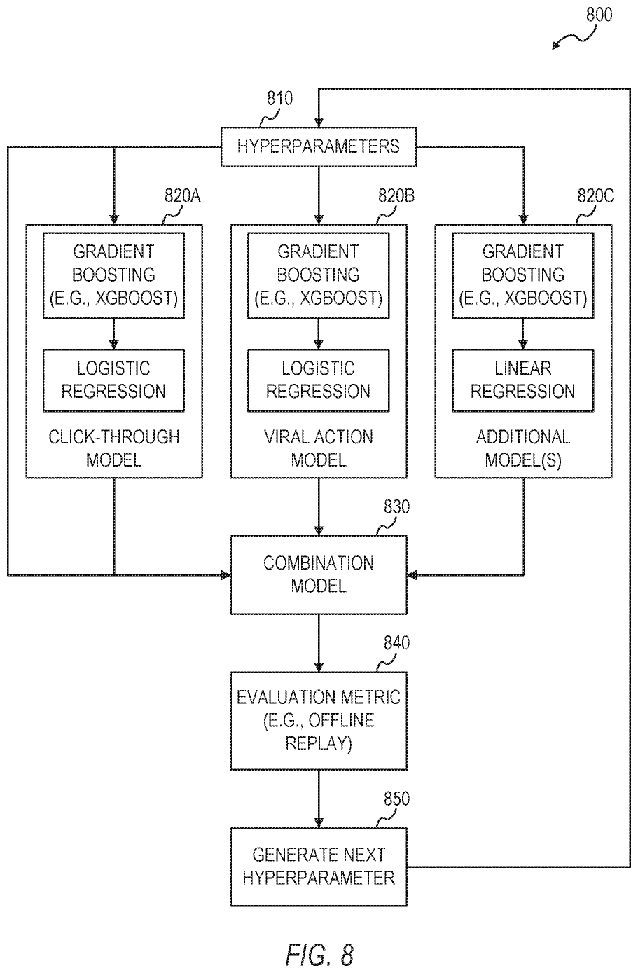

FIG. 8 is a block diagram illustrating an operational flow 800 for optimizing a combinational model, in accordance with an example embodiment. The operational flow 800 can be performed by processing logic that can comprise hardware (e.g., circuitry, dedicated logic, programmable logic, microcode, etc.), software (e.g., instructions run on a processing device), or a combination thereof. In one implementation, the operational flow 800 is performed by the feed optimization system 216 of FIG. 3, or any combination of one or more of its modules, as described above.

At operation 810, the feed optimization system 216 determines an initial set of hyperparameters to use in a machine-learning process to train the different models of the combination model, such as the click-through model, the viral action model, and optionally one or more additional models. The initial set of hyperparameters are fed into parallel machine-learning operations 820A, 820B, and 820C of the respective models. In some example embodiments, the machine learning operations 820A, 820B, and 820C each determine optimal hyperparameters for their respective models using a gradient boosting algorithm (e.g., XGBoost), and then train their respective models using a regression algorithm, their respective optimized hyperparameters, and respective training data. In some example embodiments, a logistic regression algorithm is used for the click-through model and the viral action model, while a linear regression algorithm is used for any additional models. Once the models are trained, they are combined at operation 830 to form the combination model. At operation 840, the combination model is used to generate evaluation values for different parameter configurations, such as by using historical user behavioural data (e.g., click-throughs, likes, comments, shares, no actions) with respect to digital content items as training data to determine click-through rates and viral actions rates that are used to generate evaluation values. At operation 850, updated hyperparameters are generated by performing a Gaussian process algorithm and a Thompson sampling algorithm using the evaluation values for the parameter configurations to select a subset of the parameter configurations to use as the updated hyperparameters at operation 810. This operational flow 800 continues until a point of convergence is reached, such as when the subset of parameter configurations selected at operation 850 comprises only a single parameter configuration. At this point of convergence, that single parameter configuration of the combination model may be used to select digital content items for display.

It is contemplated that any of the other features described within the present disclosure can be incorporated into the operational flow 800.

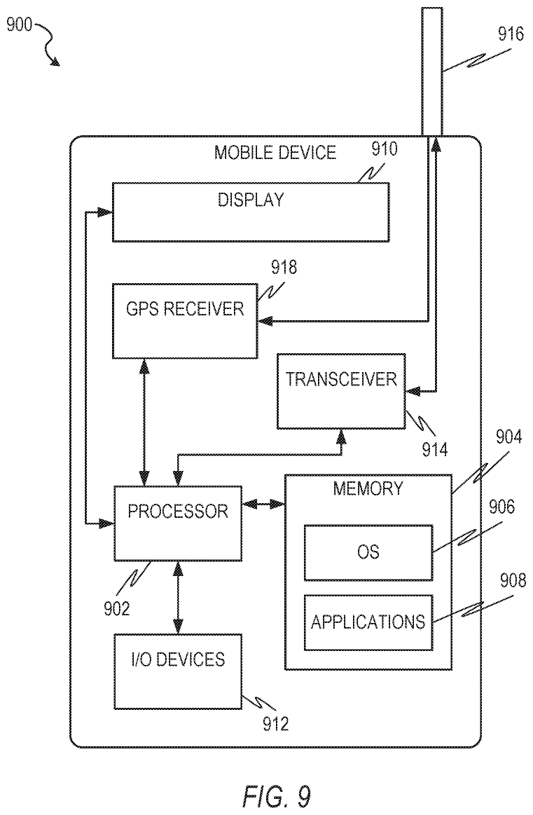

FIG. 9 is a block diagram illustrating a mobile device 900, according to an example embodiment. The mobile device 900 can include a processor 902. The processor 902 can be any of a variety of different types of commercially available processors suitable for mobile devices 900 (for example, an XScale architecture microprocessor, a Microprocessor without Interlocked Pipeline Stages (MIPS) architecture processor, or another type of processor). A memory 904, such as a random access memory (RAM), a Flash memory, or other type of memory, is typically accessible to the processor 902. The memory 904 can be adapted to store an operating system (OS) 906, as well as application programs 908, such as a mobile location-enabled application that can provide location-based services (LBSs) to a user. The processor 902 can be coupled, either directly or via appropriate intermediary hardware, to a display 910 and to one or more input/output (I/O) devices 912, such as a keypad, a touch panel sensor, a microphone, and the like. Similarly, in some embodiments, the processor 902 can be coupled to a transceiver 914 that interfaces with an antenna 916. The transceiver 914 can be configured to both transmit and receive cellular network signals, wireless data signals, or other types of signals via the antenna 916, depending on the nature of the mobile device 900. Further, in some configurations, a GPS receiver 918 can also make use of the antenna 916 to receive GPS signals.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

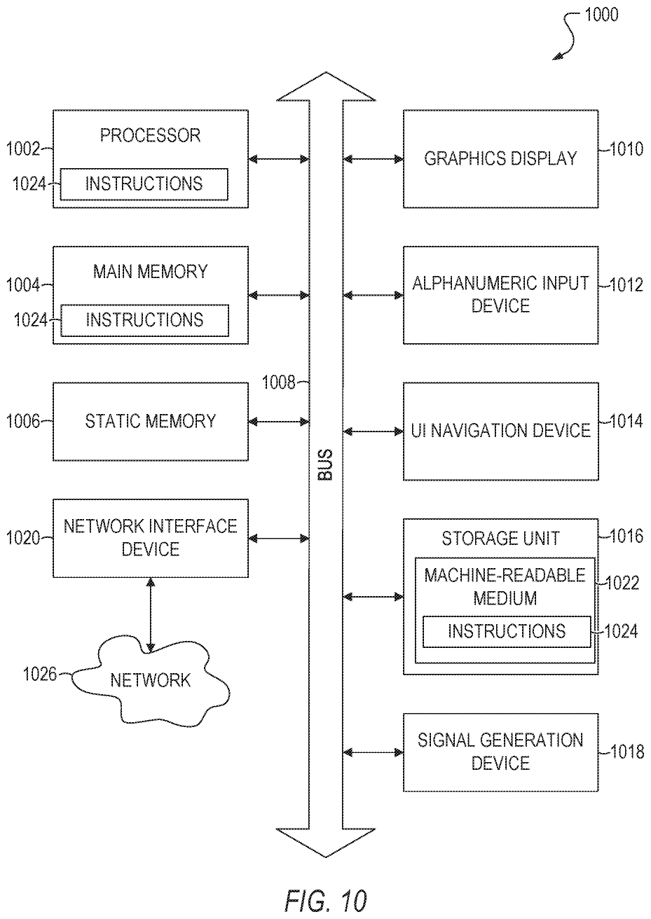

FIG. 10 is a block diagram of an example computer system 1000 on which methodologies described herein may be executed, in accordance with an example embodiment. in alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a graphics display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation device 1014 (e.g., a mouse), a storage unit 1016, a signal generation device 1018 (e.g., a speaker) and a network interface device 1020.

The storage unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding or carrying instructions (e.g., instructions 1024) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

The following numbered examples are embodiments.
1. A computer-implemented method comprising:
   generating, by a computer system having a memory and at least one hardware processor, a corresponding evaluation value for each one of a plurality of different parameter configurations for a combination model comprising a click-through model and a viral action model, the click-through model being configured to generate a click-through prediction corresponding to a first probability that a user will perform a click-through action to navigate to a digital content item when presented with an indication of the digital content item, the viral action model being configured to generate a viral action prediction corresponding to a second probability that the user will perform at least one viral action for the digital content item when presented with the indication of the digital content item, the at least one viral action comprising at least one online action that is visible to at least one other user;
   selecting, by the computer system, a subset of the plurality of different parameter configurations based on the evaluation values;
   repeating, by the computer system, the generating the corresponding evaluation value and the selecting the subset of the plurality of different parameter configurations until a single parameter configuration satisfies a convergence criteria, each repeated generating the corresponding evaluation value using the most recently selected subset of different parameter configurations in place of the plurality of different parameter configurations for the combination model; and
   selecting, by the computer system, at least one digital content item for display on a computing device using the single parameter configuration of the combination model.
2. The computer-implemented method of example 1, wherein the at least one viral action comprises at least one of liking the digital content item, commenting on the digital content item, and sharing the digital content item.
3. The computer-implemented method of example 1 or example 2, further comprising:
   determining, by the computer system, a first set of hyperparameters of a first gradient boosting algorithm for the click-through model using a first Gaussian process via expected improvement criteria and a first set of training data comprising indications of whether users performed the click-through action to navigate to digital content items when presented the digital content items;
   determining, by the computer system, a second set of hyperparameters of a second gradient boosting algorithm for the viral action model using a second Gaussian process via expected improvement criteria and a second set of training data comprising indications of whether users performed the at least one viral action for digital content items when presented with indications of the digital content items;
   training, by the computer system, the click-through model using a logistic regression algorithm, the first set of hyperparameters, and the first set of training data;
   training, by the computer system, the viral action model using the logistic regression algorithm, the second set of hyperparameters, and the second set of training data; and
   generating, by the computer system, the combination model using the trained dick-through model and the trained viral action model.
4. The computer-implemented method of example 3, wherein the first gradient boosting algorithm and the second gradient boosting algorithm each comprise an extreme gradient boosting (XGBoost) algorithm.
5. The computer-implemented method of example 3, wherein:
   the determining the first set of hyperparameters for the click-through model comprises tuning the first set of hyperparameters of the first gradient boosting algorithm using the first Gaussian process via expected improvement criteria to maximize an area under the curve (AUC) metric for the click-through model; and
   the determining the second set of hyperparameters for the viral action model comprises tuning the second set of hyperparameters using the second gradient boosting algorithm using the second Gaussian process via expected improvement criteria to maximize the AUC metric for the viral action model.
6. The computer-implemented method of example 3, wherein the first set of hyperparameters and the second set of hyperparameters comprise at least one of a maximum depth of trees and a learning rate.
7. The computer-implemented method of example 3, wherein each one of the plurality of different parameter configurations comprises a regularization weight parameter for the click-through model and a regularization weight parameter for the viral action model, the regularization weight parameter for the click-through model being used in the training of the dick-through model using the logistic regression algorithm, and the regularization weight parameter for the viral action model being used in the training of the viral action model using the logistic regression algorithm.
8. The computer-implemented method of example 3, wherein the combination model is configured to generate corresponding scores for digital content items based on the click-through model and the viral action model, and each one of the plurality of different parameter configurations comprises a combination parameter configured to weight the viral action model with respect to the click-through model in generating the corresponding scores.
9. The computer-implemented method of any one or examples 1 to 8, wherein the selecting the subset of the plurality of different parameter configurations comprises selecting the subset of the plurality of different parameter configurations based on the evaluation values of the subset using a Gaussian process algorithm and a Thompson sampling algorithm.
10. A system comprising:
   at least one processor; and
   a non-transitory computer-readable medium storing executable instructions that, when executed, cause the at least one processor to perform the method of any one of examples 1 to 9.
11. A non-transitory machine-readable storage medium, tangibly embodying a set of instructions that, when executed by at least one processor, causes the at least one processor to perform the method of any one of examples 1 to 9.
12. A machine-readable medium carrying a set of instructions that, when executed by at least one processor, causes the at least one processor to carry out the method of any one of examples 1 to 9.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
generating, by a computer system having a memory and at least one hardware processor, a corresponding evaluation value for each one of a plurality of different parameter configurations for a combination model comprising a click-through model and a viral action model, the click-through model being configured to generate a click-through prediction corresponding to a first probability that a user will perform a click-through action to navigate to a digital content item when presented with an indication of the digital content item, the viral action model being configured to generate a viral action prediction corresponding to a second probability that the user will perform at least one viral action for the digital content item when presented with the indication of the digital content item, the at least one viral action comprising at least one online action that is visible to at least one other user;
selecting, by the computer system, a subset of the plurality of different parameter configurations based on the evaluation values of the subset;
repeating, by the computer system, the generating the corresponding evaluation value and the selecting the subset of the plurality of different parameter configurations until a single parameter configuration satisfies a convergence criteria, each repeated generating the corresponding evaluation value using the most recently selected subset of different parameter configurations in place of the plurality of different parameter configurations for the combination model; and
selecting, by the computer system, at least one digital content item for display on a computing device using the single parameter configuration of the combination model.

2. The computer-implemented method of claim 1, wherein the at least one viral action comprises at least one of liking the digital content item, commenting on the digital content item, and sharing the digital content item.

3. The computer-implemented method of claim 1, further comprising:
determining, by the computer system, a first set of hyperparameters of a first gradient boosting algorithm for the click-through model using a first Gaussian process via expected improvement criteria and a first set of training data comprising indications of whether users performed the click-through action to navigate to digital content items when presented the digital content items;
determining, by the computer system, a second set of hyperparameters of a second gradient boosting algorithm for the viral action model using a second Gaussian process via expected improvement criteria and a second set of training data comprising indications of whether users performed the at least one viral action for digital content items when presented with indications of the digital content items;
training, by the computer system, the click-through model using a logistic regression algorithm, the first set of hyperparameters, and the first set of training data;
training, by the computer system, the viral action model using the logistic regression algorithm, the second set of hyperparameters, and the second set of training data; and
generating, by the computer system, the combination model using the trained click-through model and the trained viral action model.

4. The computer-implemented method of claim 3, wherein the first gradient boosting algorithm and the second gradient boosting algorithm each comprise an extreme gradient boosting (XGBoost) algorithm.

5. The computer-implemented method of claim 3, wherein:
the determining the first set of hyperparameters for the click-through model comprises tuning the first set of hyperparameters of the first gradient boosting algorithm using the first Gaussian process via expected improvement criteria to maximize an area under the curve (AUC) metric for the click-through model; and
the determining the second set of hyperparameters for the viral action model comprises tuning the second set of hyperparameters using the second gradient boosting algorithm using the second Gaussian process via expected improvement criteria to maximize the AUC metric for the viral action model.

6. The computer-implemented method of claim 3, wherein the first set of hyperparameters and the second set of hyperparameters comprise at least one of a maximum depth of trees and a learning rate.

7. The computer-implemented method of claim 3, wherein each one of the plurality of different parameter configurations comprises a regularization weight parameter for the click-through model and a regularization weight parameter for the viral action model, the regularization weight parameter for the click-through model being used in the training of the click-through model using the logistic regression algorithm, and the regularization weight parameter for the viral action model being used in the training of the viral action model using the logistic regression algorithm.

8. The computer-implemented method of claim 3, wherein the combination model is configured to generate corresponding scores for digital content items based on the click-through model and the viral action model, and each one of the plurality of different parameter configurations comprises a combination parameter configured to weight the viral action model with respect to the click-through model in generating the corresponding scores.

9. The computer-implemented method of claim 1, wherein the selecting the subset of the plurality of different parameter configurations comprises selecting the subset of the plurality of different parameter configurations based on the evaluation values of the subset using a Gaussian process algorithm and a Thompson sampling algorithm.

10. A system comprising:
at least one hardware processor; and
a non-transitory machine-readable medium embodying a set of instructions that, when executed by the at least one hardware processor, cause the at least one hardware processor to perform operations, the operations comprising:
generating a corresponding evaluation value for each one of a plurality of different parameter configurations for a combination model comprising a click-through model and a viral action model, the click-through model being configured to generate a click-through prediction corresponding to a first probability that a user will perform a click-through action to navigate to a digital content item when presented with an indication of the digital content item, the viral action model being configured to generate a viral action prediction corresponding to a second probability that the user will perform at least one viral action for the digital content item when presented with the indication of the digital content item, the at least one viral action comprising at least one online action that is visible to at least one other user;
selecting a subset of the plurality of different parameter configurations based on the evaluation values of the subset;
repeating the generating the corresponding evaluation value and the selecting the subset of the plurality of different parameter configurations until a single parameter configuration satisfies a convergence criteria, each repeated generating the corresponding evaluation value using the most recently selected subset of different parameter configurations in place of the plurality of different parameter configurations for the combination model; and
selecting at least one digital content item for display on a computing device using the single parameter configuration of the combination model.

11. The system of claim 10, wherein the at least one viral action comprises at least one of liking the digital content item, commenting on the digital content item, and sharing the digital content item.

12. The system of claim 10, wherein the operations further comprise:
determining a first set of hyperparameters of a first gradient boosting algorithm for the click-through model using a first Gaussian process via expected improvement criteria and a first set of training data comprising indications of whether users performed the click-through action to navigate to digital content items when presented the digital content items;
determining a second set of hyperparameters of a second gradient boosting algorithm for the viral action model using a second Gaussian process via expected improvement criteria and a second set of training data comprising indications of whether users performed the at least one viral action for digital content items when presented with indications of the digital content items;
training the click-through model using a logistic regression algorithm, the first set of hyperparameters, and the first set of training data;
training the viral action model using the logistic regression algorithm, the second set of hyperparameters, and the second set of training data; and
generating the combination model using the trained click-through model and the trained viral action model.

13. The system of claim 12, wherein the first gradient boosting algorithm and the second gradient boosting algorithm each comprise an extreme gradient boosting (XGBoost) algorithm.

14. The system of claim 12, wherein:
the determining the first set of hyperparameters for the click-through model comprises tuning the first set of hyperparameters of the first gradient boosting algorithm using the first Gaussian process via expected improvement criteria to maximize an area under the curve (AUC) metric for the click-through model; and
the determining the second set of hyperparameters for the viral action model comprises tuning the second set of hyperparameters using the second gradient boosting algorithm using the second Gaussian process via expected improvement criteria to maximize the AUC metric for the viral action model.

15. The system of claim 12, wherein the first set of hyperparameters and the second set of hyperparameters comprise at least one of a maximum depth of trees and a learning rate.

16. The system of claim 12, wherein each one of the plurality of different parameter configurations comprises a regularization weight parameter for the click-through model and a regularization weight parameter for the viral action model, the regularization weight parameter for the click-through model being used in the training of the click-through model using the logistic regression algorithm, and the regularization weight parameter for the viral action model being used in the training of the viral action model using the logistic regression algorithm.

17. The system of claim 12, wherein the combination model is configured to generate corresponding scores for digital content items based on the click-through model and the viral action model, and each one of the plurality of different parameter configurations comprises a combination parameter configured to weight the viral action model with respect to the click-through model in generating the corresponding scores.

18. A non-transitory machine-readable medium embodying a set of instructions that, when executed by at least one hardware processor, cause the at least one hardware processor to perform operations, the operations comprising:
generating a corresponding evaluation value for each one of a plurality of different parameter configurations for a combination model comprising a click-through model and a viral action model, the click-through model being configured to generate a click-through prediction corresponding to a first probability that a user will perform a click-through action to navigate to a digital content item when presented with an indication of the digital content item, the viral action model being configured to generate a viral action prediction corresponding to a second probability that the user will perform at least one viral action for the digital content item when presented with the indication of the digital content item, the at least one viral action comprising at least one online action that is visible to at least one other user;
selecting a subset of the plurality of different parameter configurations based on the evaluation values of the subset;
repeating the generating the corresponding evaluation value and the selecting the subset of the plurality of different parameter configurations until a single parameter configuration satisfies a convergence criteria, each repeated generating the corresponding evaluation value using the most recently selected subset of different parameter configurations in place of the plurality of different parameter configurations for the combination model; and
selecting at least one digital content item for display on a computing device using the single parameter configuration of the combination model.

19. The non-transitory machine-readable medium of claim 18, wherein the at least one viral action comprises at least one of liking the digital content item, commenting on the digital content item, and sharing the digital content item.

20. The non-transitory machine-readable medium of claim 18, wherein the operations further comprise:
determining a first set of hyperparameters of a first gradient boosting algorithm for the click-through model using a first Gaussian process via expected improvement criteria and a first set of training data comprising indications of whether users performed the click-through action to navigate to digital content items when presented the digital content items;
determining a second set of hyperparameters of a second gradient boosting algorithm for the viral action model using a second Gaussian process via expected improvement criteria and a second set of training data comprising indications of whether users performed the at least one viral action for digital content items when presented with indications of the digital content items;
training the click-through model using a logistic regression algorithm, the first set of hyperparameters, and the first set of training data;
training the viral action model using the logistic regression algorithm, the second set of hyperparameters, and the second set of training data; and
generating the combination model using the trained click-through model and the trained viral action model.
